(19) United States
(12) Patent Application Publication
(10) Pub. No.: US 2012/0043002 A1
(43) Pub. Date: Feb. 23, 2012

(54) PNEUMATIC AIRCRAFT TIRE

(76) Inventor: John Eric Arnold, North Canton, OH (US)

(21) Appl. No.: 12/861,002

(22) Filed: Aug. 23, 2010

(51) Int. Cl. B60C 9/02

(52) U.S. Cl. 152/552

(57) ABSTRACT

A pneumatic tire includes a tread, a crown reinforcement radially inward of the tread, a pair of bead cores, a carcass structure radially inward of the crown reinforcement and wound around the bead cores, an innerliner radially inward of the carcass structure, and a barrier layer interposed between the carcass structure and the innerliner. The barrier layer includes two fabric pieces one on each side of a center line of the pneumatic tire. One end of each fabric piece is located near the centerline of the pneumatic tire. The other end of each fabric piece being wrapped around the bead cores and terminating at least at the radial outermost part of the bead cores.

### FIELD OF THE INVENTION

The present invention relates to a pneumatic tire, and more particularly, to a pneumatic aircraft tire with a barrier layer.

### BACKGROUND OF THE INVENTION

The carcass reinforcements of conventional aircraft tires generally comprise several plies of textile cords, which are typically anchored in each bead to at least one single wire bead core. These reinforcements are wound around the bead wire from the inside to the outside, forming turn-ups, the respective ends of which are spaced radially from the axis of rotation of the tire. The severe conditions under which aircraft tires are used are such that the life of the beads is short, particularly in the area of the turn-ups of the carcass reinforcement.

An improvement in performance may be obtained by the separating of the plies of the carcass reinforcement into two groups. The first group may comprise the plies of the carcass reinforcement which are axially inward of the beads, these plies being then wound around a bead wire in each bead from the inside to the outside of the tire. The second group may be formed of at least one axially outer ply in the region of the beads, which ply is generally wound around the bead wire from the outside to the inside of the tire.

The endurance of these beads thus may be improved by the presence within each bead of an additional reinforcement ply wound around the bead wire and thus forming an axially outer strand and an axially inner strand, the reinforcement ply being the ply closest to the filling or infill rubber profiled element, which is generally triangular and radially above the anchoring bead wire.

The endurance of the beads of aircraft tires are subjected to large loads which may impart thereto deflections of the order of 50% of their height and more. The large number of carcass plies also creates a large number of free ends of the reinforcement elements and interfaces between plies leading to greater hysteresis losses and therefore higher operating temperatures, all of which are factors contributing to fatigue failure and shorter operational life of the beads and the tires.

One conventional aircraft tire has a tread, a crown reinforcement, and a radial carcass reinforcement. The radial carcass reinforcement comprises a plurality of textile reinforcement elements oriented substantially radially (that is to say forming an angle of between 80° and 100° relative to the circumferential direction). The radial reinforcement elements of the carcass reinforcement of this tire are composite cables formed by plying at least one yarn having a modulus of elasticity in tension at least equal to 2000 cN/tex, with at least one yarn having a modulus of elasticity upon traction at most equal to 1500 cN/tex. The moduli of these yarns is measured for a tensile force equal to ten percent (10%) of the breaking load of each yarn. Similarly the crown reinforcement may use these composite cables.

Conventional pneumatic aircraft tires are a composite of at least two primary materials: elastomer and fibers. The materials are combined to produce rubberized fibers used as reinforcement in the tire. Common fibers are polyester, rayon, nylon, aromatic polyamide, and aramid, all of which are formed into cords prior to being incorporated into elastomers. The rubberized fibers give a tire its shape, size, stability, load carrying capacity, fatigue, bruise resistance, etc.

Fiber cords are used in all the different areas of the tire where reinforcement means are required: in the carcass as a reinforcing ply for the entire carcass or in sidewall regions; in the belt or breaker structures as primary reinforcing plies or as overlays or underlays; in the bead region as flipper or chipper plies. In the different areas of the tire, the fiber cord is relied upon to provide properties specific to that region of the tire. Thus, for each area of the tire, a single type of fiber may be treated or corded in numerous ways to provide different benefits.

Prior to being incorporated into elastomer, the fiber cord is adhesively treated to ensure bonding of the fiber to the elastomer. The selected adhesive is determined so as to be compatible with the fiber being used and to permit the fiber to remain bonded to the elastomer during curing and use of the tire. An adhesive selected for use with nylon fibers will not be compatible with polyester fibers due to the different chemical structure of the adhesive and the fiber.

In treating the fiber, there are three main variables to consider: time, temperature, and tension. Each of these variables is optimized depending upon the type of fiber cord being treated, i.e., nylon versus rayon versus aramid, and the adhesive being used to create bonding between the elastomer and fiber. The time must be sufficient to allow the adhesive to bond with the fiber and set; the temperature must be sufficient to activate the adhesive; and the tension must be sufficient to ensure penetration of the adhesive, permit the fiber to move through the processing unit, and develop the requisite physical properties such as modulus, shrinkage and extensibility that are required.

In selecting a fiber cord for reinforcing a tire, the cord properties are selected to achieve desired goals. When different properties are desired and a single fiber type cannot provide the desired characteristics to the tire, different materials may be combined. A reinforcement ply may use alternating types of parallel cords.

Core/sheath types of filaments are also known. In a conventional core/sheath type of filament, such as that disclosed by U.S. Pat. No. 5,221,384 (Takahashi), the sheath is a polyamide sheath and a polyester core, with a sheath/core cross-sectional ratio of 90:10 to 10:90 down to 70:30 to 30:70. In such a cord, one skilled in the art recognizes that a true core/sheath filament exists by the resultant properties of the filament. For example, if the Takahashi filament is 10% sheath of polyamide and 90% core of polyester, the resulting properties typically follow the rules of a mixture whereby the 10% of one property of the polyamide is added to 90% of the property of the polyester. A core/sheath filament is formed through high speed spinning wherein the two different materials are spun through nested openings in the spinneret and taking advantage of die swell for the two different materials to contact and bond during orientation of the filament.

The invention of US 2005/10133137 was directed to a blended fiber cord used for reinforcing tires and pneumatic tires comprising such cords. The cords, in combination with a preferred adhesive, achieved a high degree of thermal stability allowing for the use of such cords in various reinforcing plies for a pneumatic tire and for preferred use for such cords in areas of the tire subjected to high temperatures either in curing or performance.

The object of the present invention is to achieve superior cord extensibilities while meeting the required strength performance for the severe load and deflection requirements of radial aircraft tire designs.

Unlike the tire of the US publication 2005/0133137 which employed a blended aramid and polyester cord intended primarily for use in a passenger runflat tire or agricultural tire, the present invention employs a unique merged cord employing aramid or aromatic polyamide fibers and nylon or aliphatic polyamide fibers in an aircraft tire as described below.

### SUMMARY OF THE INVENTION

A pneumatic tire in accordance with the present invention includes a tread, a crown reinforcement radially inward of the tread, a pair of bead cores, a carcass structure radially inward of the crown reinforcement and wound around the bead cores, an innerliner radially inward of the carcass structure, and a barrier layer interposed between the carcass structure and the innerliner. The barrier layer includes two fabric pieces one on each side of a center line of the pneumatic tire. One end of each fabric piece is located near the centerline of the pneumatic tire. The other end of each fabric piece being wrapped around the bead cores and terminating at least at the radial outermost part of the bead cores.

According to another aspect of the present invention, the other end of each fabric piece is disposed between ⅙ and ¼ of a section width of the pneumatic tire from the centerline.

According to still another aspect of the present invention, the barrier layer is reinforced by fabric cords between 750 denier and 1000 denier.

According to yet another aspect of the present invention, the barrier layer is reinforced by fabric cords of 842 denier.

According to still another aspect of the present invention, the barrier layer has an end count between 21 ends per inch and 35 ends per inch.

According to yet another aspect of the present invention, the barrier layer is reinforced by nylon cords.

According to yet another aspect of the present invention, the barrier layer is reinforced by cords at angles between 80 degrees and 90 degrees relative to a radial direction of the pneumatic tire.

According to still another aspect of the present invention, the cords have an 86 degree angle relative to the radial; direction.

### DEFINITIONS

The following definitions are controlling for the disclosed invention.

“Apex” means an elastomeric filler located radially above the bead core and between the plies and the turnup ply.

“Annular” means formed like a ring.

“Aspect ratio” means the ratio of its section height to its section width.

“Axial” and “axially” are used herein to refer to lines or directions that are parallel to the axis of rotation of the tire.

“Bead” means that part of the tire comprising an annular tensile member wrapped by ply cords and shaped, with or without other reinforcement elements such as flippers, chippers, apexes, toe guards and chafers, to fit the design rim.

“Belt structure” means at least two annular layers or plies of parallel cords, woven or unwoven, underlying the tread, unanchored to the bead, and having cords inclined respect to the equatorial plane of the tire. The belt structure may also include plies of parallel cords inclined at relatively low angles, acting as restricting layers.

“Bias tire” (cross ply) means a tire in which the reinforcing cords in the carcass ply extend diagonally across the tire from bead to bead at about a 25°-65° angle with respect to equatorial plane of the tire. If multiple plies are present, the ply cords run at opposite angles in alternating layers.

“Breakers” means at least two annular layers or plies of parallel reinforcement cords having the same angle with reference to the equatorial plane of the tire as the parallel reinforcing cords in carcass plies. Breakers are usually associated with bias tires.

“Cable” means a cord formed by twisting together two or more plied yarns.

“Carcass” means the tire structure apart from the belt structure, tread, undertread, and sidewall rubber over the plies, but including the beads.

“Casing” means the carcass, belt structure, beads, sidewalls and all other components of the tire excepting the tread and undertread, i.e., the whole tire.

“Chipper” refers to a narrow band of fabric or steel cords located in the bead area whose function is to reinforce the bead area and stabilize the radially inwardmost part of the sidewall.

“Circumferential” means lines or directions extending along the perimeter of the surface of the annular tire parallel to the Equatorial Plane (EP) and perpendicular to the axial direction; it can also refer to the direction of the sets of adjacent circular curves whose radii define the axial curvature of the tread, as viewed in cross section.

“Cord” means one of the reinforcement strands of which the reinforcement structures of the tire are comprised.

“Cord angle” means the acute angle, left or right in a plan view of the tire, formed by a cord with respect to the equatorial plane. The “cord angle” is measured in a cured but uninflated tire.

“Crown” means that portion of the tire within the width limits of the tire tread.

“Denier” means the weight in grams per 9000 meters (unit for expressing linear density). Dtex means the weight in grams per 10,000 meters.

“Density” means weight per unit length.

“Elastomer” means a resilient material capable of recovering size and shape after deformation.

“Equatorial plane (EP)” means the plane perpendicular to the tire's axis of rotation and passing through the center of its tread; or the plane containing the circumferential centerline of the tread.

“Fabric” means a network of essentially unidirectionally extending cords, which may be twisted, and which in turn are composed of a plurality of a multiplicity of filaments (which may also be twisted) of a high modulus material.

“Fiber” is a unit of matter, either natural or man-made that forms the basic element of filaments. Characterized by having a length at least 100 times its diameter or width.

“Filament count” means the number of filaments that make up a yarn. Example: 1000 denier polyester has approximately 190 filaments.

“Flipper” refers to a reinforcing fabric around the bead wire for strength and to tie the bead wire in the tire body.

“Gauge” refers generally to a measurement, and specifically to a thickness measurement.

“High Tensile Steel (HT)” means a carbon steel with a tensile strength of at least 3400 MPa @ 0.20 mm filament diameter.

“Inner” means toward the inside of the tire and “outer” means toward its exterior.

“Innerliner” means the layer or layers of elastomer or other material that form the inside surface of a tubeless tire and that contain the inflating fluid within the tire.

“LASE” is load at specified elongation.

“Lateral” means an axial direction.

“Lay length” means the distance at which a twisted filament or strand travels to make a 360 degree rotation about another filament or strand.

“Load Range” means load and inflation limits for a given tire used in a specific type of service as defined by tables in The Tire and Rim Association, Inc.

“Mega Tensile Steel (MT)” means a carbon steel with a tensile strength of at least 4500 MPa @ 0.20 mm filament diameter.

“Normal Load” means the specific design inflation pressure and load assigned by the appropriate standards organization for the service condition for the tire.

“Normal Tensile Steel (NT)” means a carbon steel with a tensile strength of at least 2800 MPa @ 0.20 mm filament diameter.

“Ply” means a cord-reinforced layer of rubber-coated radially deployed or otherwise parallel cords.

“Radial” and “radially” are used to mean directions radially toward or away from the axis of rotation of the tire.

“Radial Ply Structure” means the one or more carcass plies or which at least one ply has reinforcing cords oriented at an angle of between 65° and 90° with respect to the equatorial plane of the tire.

“Radial Ply Tire” means a belted or circumferentially-restricted pneumatic tire in which at least one ply has cords which extend from bead to bead are laid at cord angles between 65° and 90° with respect to the equatorial plane of the tire.

“Rivet” means an open space between cords in a layer.

“Section Height” means the radial distance from the nominal rim diameter to the outer diameter of the tire at its equatorial plane.

“Section Width” means the maximum linear distance parallel to the axis of the tire and between the exterior of its sidewalls when and after it has been inflated at normal pressure for 24 hours, but unloaded, excluding elevations of the sidewalls due to labeling, decoration or protective bands.

“Sidewall” means that portion of a tire between the tread and the bead.

“Stiffness ratio” means the value of a control belt structure stiffness divided by the value of another belt structure stiffness when the values are determined by a fixed three point bending test having both ends of the cord supported and flexed by a load centered between the fixed ends.

“Super Tensile Steel (ST)” means a carbon steel with a tensile strength of at least 3650 MPa @ 0.20 mm filament diameter.

“Tenacity” is stress expressed as force per unit linear density of the unstrained specimen (gm/ex or gm/denier). Tenacity is mainly used in textiles.

“Tensile” is stress expressed in forces/cross-sectional area. Strength in psi=12,800 times specific gravity times tenacity in grams per denier.

“Toe guard” refers to the circumferentially deployed elastomeric rim-contacting portion of the tire axially inward of each bead.

“Tread” means a molded rubber component which, when bonded to a tire casing, includes that portion of the tire that comes into contact with the road when the tire is normally inflated and under normal load.

“Tread width” means the arc length of the tread surface in a plane including the axis of rotation of the tire.

“Turnup end” means the portion of a carcass ply that turns upward (i.e., radially outward) from the beads about which the ply is wrapped.

“Ultra Tensile Steel (UT)” means a carbon steel with a tensile strength of at least 4000 MPa @ 0.20 mm filament diameter.

“Yarn” is a generic term for a continuous strand of textile fibers or filaments. Yarn occurs in the following forms: 1) a number of fibers twisted together; 2) a number of filaments laid together without twist; 3) a number of filaments laid together with a degree of twist; 4) a single filament with or without twist (monofilament); 5) a narrow strip of material with or without twist.

### BRIEF DESCRIPTION OF THE DRAWINGS

The invention will be described by way of example and with reference to the accompanying drawings in which:

FIG. 1 is a cross sectional view of an example pneumatic tire in accordance with the present invention.

FIG. 2 is a cross sectional view of the bead area of the example tire of FIG. 1.

FIG. 3 is an additional view of the bead area of FIG. 2.

### DETAILED DESCRIPTION OF AN EXAMPLE EMBODIMENT THE PRESENT INVENTION

The following language is an example of the best presently contemplated mode or modes of carrying out the present invention. This description is made for the purpose of illustrating the general principals of the present invention and should not be taken in a limiting sense. The scope of the present invention is best determined by reference to the appended claims.

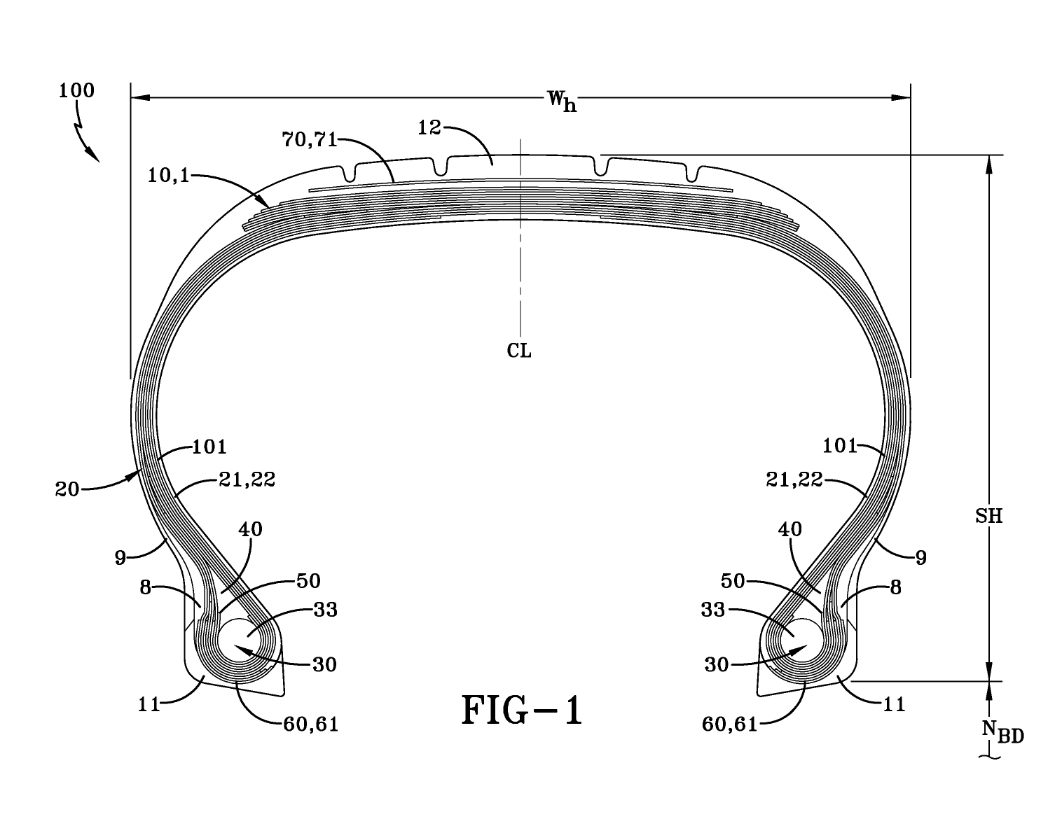

FIG. 1 illustrates an exemplary pneumatic aircraft tire 100 in accordance with the present invention. The example tire 100 has a tread 12 with sidewall portions 9 connected to, and extending from, lateral edges of the tread 12. At radially inner ends of each sidewall 9 is a bead portion 30. Each bead portion 30 has therein a bead core 33, an apex 40 extending radially outward from the bead core 33, and may have at least one reinforcing chafer layer 60 reinforced with cords 61 to reduce rim chafing of the pneumatic tire 100. A carcass reinforcing ply structure 20 extends from one bead portion 30 to the opposing bead portion with turnup portions.

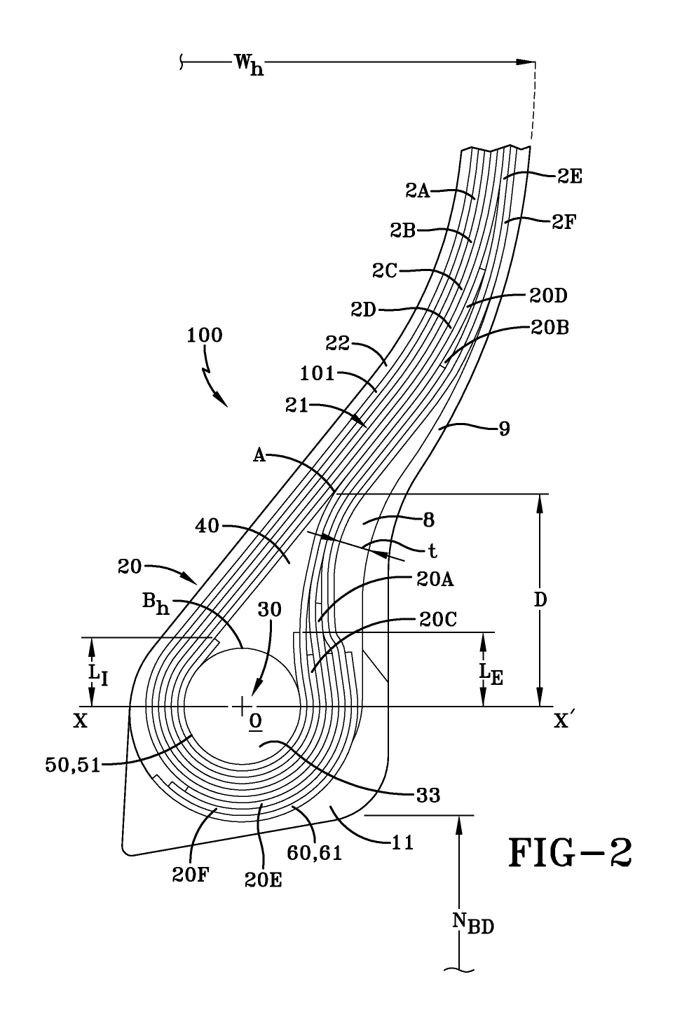

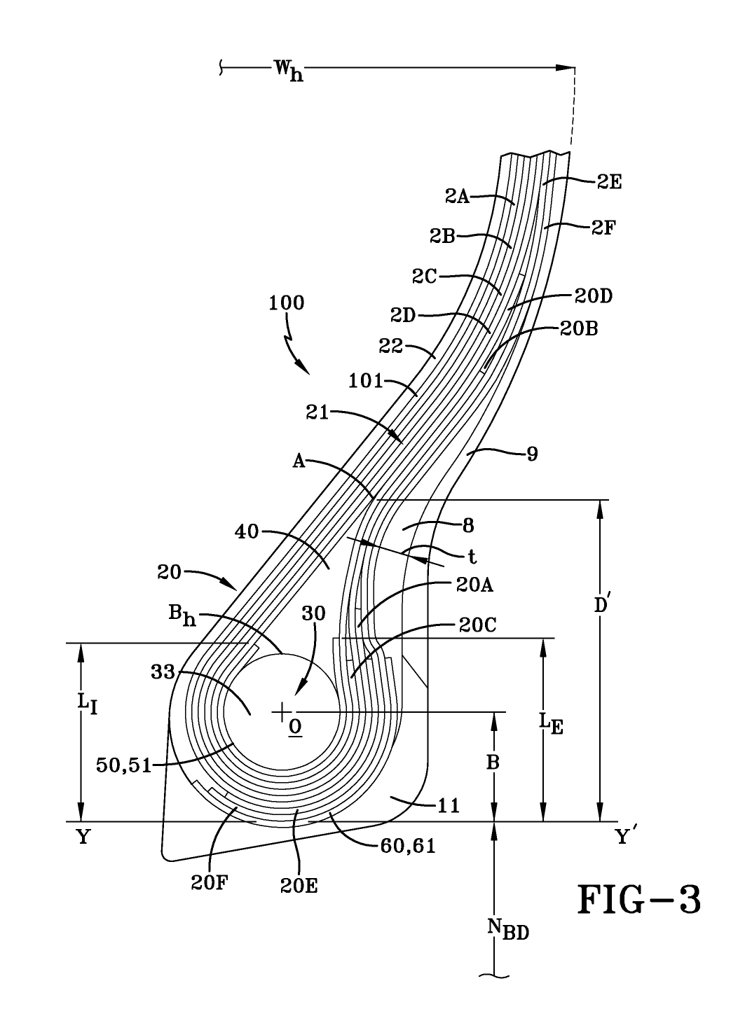

With reference to FIGS. 2 and 3, the carcass structure 20 is formed of six plies 2A to 2F of radial textile cords 21. Among these six plies, four axially inner plies 2A, 2B, 2C and 2D are wound about each circular bead core 33. These four plies extend from the inside to the outside of the example tire 100 in order to form turn-ups 20A, 20B, 20C and 20D. The carcass structure 20 is disposed radially outward of an air-impermeable innerliner 22 of example tire 100.

Outward of the bead cores 33 is the strip or filler apex 40 of elastomeric material having a substantially triangular shape extending to a terminal end A radially farthest from the axis of rotation of the tire 100 and located a distance D from a reference line XX′. As was shown in FIG. 1 the reference line XX′ is also parallel to the axis of rotation of the tire 100 and extends through the geometric center O of the cross section of each bead core 33.

A flipper 50, which may be formed of textile cords 51 similar to those of the cords 21 of the carcass structure 20, is located with an inner end L_{I} slightly above the radially outer height Bₕ of the bead core 33 and an outer end L_{E} is also shown slightly above the bead core 33, as measured from reference line YY′. The ends L_{I}, L_{E} may satisfy a relationship wherein Bₕ<L_{I} and L_{E}<0.7D as measured from the nominal bead diameter N_{BD}. To minimize the space occupied by the flipper 50, the cords 51 may be made of a diameter smaller than the ply cords 21.

The carcass structure 20 further has two carcass plies 2E, 2F, hereinafter called outer plies. These outer plies 2E, 2F cover the turn-ups 20A-20D of the inner plies 2A-2D. The outer plies 2E, 2F are wound around each bead core 33 over a portion of a circular arc at least axially inward of the cross-sectional center of each bead core 33. The ply ends 20E, 20F are thus axially (or laterally) inward of the lowest portion of the bead core 33. The ply ends 20E, 20F are thus effectively pinched between each bead core 33 and a rim seat, thereby helping to securely anchor these outer plies 2E, 2F.

The bead area 30 may have an outer chipper 60 of textile cords 61 wrapped around the ply ends 20E, 20F, protecting the carcass plies 2A-2F against damage during mounting. Typically, radially below the chipper 60 may be a chafer 11 having a rubber gauge in the range of 0.04 inches (1.0 mm) to about 0.16 inches (4.1 mm).

Axially outward of the chafer 11 and the plies 20E, 20F may be an elongated strip 8 of elastomeric material extending from radially inward of the bead core 33 adjacent the chafer to a radial location at or slightly above the turn-up 20B, but below the turn-up 20D. This strip 8 may be interposed between the sidewall rubber 9 and the outer ply 20F. At a location almost equal to the radial height D of the terminal end A, the strip 8 may have a maximum thickness t. In this example, the maximum thickness t is 0.3 inches (7.6 mm).

Outward of the carcass structure 20 is a belt structure 10 (FIG. 1). The belt structure 10 has at least two ply layers of cords 1, the cords being inclined at an angle of between 5 and 35 degrees. The cords 1 in each ply layer are parallel to each other and crossed relative to the cords in the adjacent layer.

In accordance with the present invention, a barrier layer 101 of low denier, high end count fabric may be placed between the innermost ply 2A and the innerliner 22 for preventing migration of the innerliner compound into the ply compound and to further increase strength to the tire casing. This barrier layer 101 may consist of two fabric pieces—one on each side of the centerline CL of the tire 100. In cross section (FIG. 1), one end of each fabric piece may be located near the centerline CL of the tire 100 in the crown portion of the tire. These ends may be disposed between ⅙ and ¼ of the section width Wₕ of the tire from the centerline CL.

The opposite ends of the pieces of the barrier layer 101 may wrap around the bead cores 33 and terminate at least at the top of the bead cores. The barrier layer 101 may be reinforced by low denier cords fabric, such as between 750 denier and 1000 denier, or particularly 842 denier. The barrier layer 101 may have an end count between 21 ends per inch (epi) and 35 epi. The cords may be nylon or other suitable material and at angles between 80 degrees and 90 degrees relative to the radial direction, or particularly 86 degrees.

As a green tire is shaped on a carcass drum into a belt package, a relatively low angle barrier fabric may provide isolation between the low-adhesion innerliner compound and the ply compound. This protection has traditionally been provided with a heavy layer of innerliner compound. The anchored fabric barrier layer 101 may allow the innerliner gage to be reduced, which may result in a lighter weight and less costly tire.

Radial aircraft tires, especially those with high blow-up ratios (mold OD/bead ID) may particularly benefit from such a barrier layer 101. Conventional bias ply aircraft tires employ a one-piece fabric barrier layer with ends terminating above the bead cores (with no wrap around). Since such a conventional layer is not anchored to the bead cores, the layer does not contribute fully to the strength of the tire casing, nor does this barrier layer help control the inflated section width Wₕ of the tire 100. The anchored barrier layer 101 of the present invention, however, adds strength to the tire casing, increases burst values, and assists in section width Wₕ control.

As stated above, a barrier layer 101 in accordance with the present invention produces excellent strength improvement and mitigates innerliner material migration. This barrier layer 101 thus enhances the performance of the tire 100, even though the complexities of the structure and behavior of the pneumatic tire are such that no complete and satisfactory theory has been propounded. Temple, Mechanics of Pneumatic Tires (2005). While the fundamentals of classical composite theory are easily seen in pneumatic tire mechanics, the additional complexity introduced by the many structural components of pneumatic tires readily complicates the problem of predicting tire performance. Mayni, Composite Effects on Tire Mechanics (2005). Additionally, because of the non-linear time, frequency, and temperature behaviors of polymers and rubber, analytical design of pneumatic tires is one of the most challenging and underappreciated engineering challenges in today's industry. Mayni.

A pneumatic tire has certain essential structural elements. United States Department of Transportation, Mechanics of Pneumatic Tires, pages 207-208 (1981). An important structural element is the carcass ply, typically made up of many flexible, high modulus cords of natural textile, synthetic polymer, glass fiber, or fine hard drawn steel embedded in, and bonded to, a matrix of low modulus polymeric material, usually natural or synthetic rubber. Id. at 207 through 208.

The flexible, high modulus cords are usually disposed as a single layer. Id. at 208. Tire manufacturers throughout the industry cannot agree or predict the effect of different twists of carcass ply cords on noise characteristics, handling, durability, comfort, etc. in pneumatic tires, Mechanics of Pneumatic Tires, pages 80 through 85.

These complexities are demonstrated by the below table of the interrelationships between tire performance and tire components.

| | | CARCASS | | | | | |
|---|---|---|---|---|---|---|---|
| | LINER | PLY | APEX | BELT | OV'LY | TREAD | MOLD |
| TREAD WEAR | | | | X | | X | X |
| NOISE | | X | X | X | X | X | X |
| HANDLING | | X | X | X | X | X | X |
| TRACTION | | | | | | X | X |
| DURABILITY | X | X | X | X | X | X | X |
| ROLL RESIST | X | | X | X | | X | X |
| RIDE | X | X | X | | | X | |
| COMFORT | | | | | | | |
| HIGH SPEED | | X | X | X | X | X | X |
| AIR | X | | | | | | |
| RETENTION | | | | | | | |
| MASS | X | X | X | X | X | X | X |

As seen in the table, carcass and innerliner characteristics affect the other components of a pneumatic tire (i.e., carcass and innerliner affect apex, belt, overlay, etc.), leading to a number of components interrelating and interacting in such a way as to affect a group of functional properties (noise, handling, durability, comfort, high speed, and mass), resulting in a completely unpredictable and complex composite. Thus, changing even one component can lead to directly improving or degrading as many as the above ten functional characteristics, as well as altering the interaction between that one component and as many as six other structural components. Each of those six interactions may thereby indirectly improve or degrade those ten functional characteristics. Whether each of these functional characteristics is improved, degraded, or unaffected, and by what amount, certainly would have been unpredictable without the experimentation and testing conducted by the inventors. Since the barrier layer 101 is disposed between the carcass 21 and the innerliner 22, both the carcass and innerliner are altered.

Thus, for example, when the structure (i.e., twist, cord construction, etc.) of the carcass and/or innerliner is modified with the intent to improve one functional property of the pneumatic tire, any number of other functional properties may be unacceptably degraded. Furthermore, the interaction between the carcass and innerliner and the apex, belt, and tread may also unacceptably affect the functional properties of the pneumatic tire. A modification of the carcass and/or innerliner may not even improve that one functional property because of these complex interrelationships.

Thus, as stated above, the complexity of the interrelationships of the multiple components makes the actual result of modification of a carcass and/or innerliner, in accordance with the present invention, impossible to predict or foresee from the infinite possible results. Only through extensive experimentation has the barrier layer 101 of the present invention been revealed as an excellent, unexpected, and unpredictable option for a pneumatic tire.

The previous descriptive language is of the best presently contemplated mode or modes of carrying out the present invention. This description is made for the purpose of illustrating an example of general principles of the present invention and should not be interpreted as limiting the present invention. The scope of the present invention is best determined by reference to the appended claims. The reference numerals as depicted in the schematic drawings are the same as those referred to in the specification. For purposes of this application, the various examples illustrated in the figures each use a same reference numeral for similar components. The examples structures may employ similar components with variations in location or quantity thereby giving rise to alternative constructions in accordance with the present invention.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

What is claimed is:

1. A pneumatic tire comprising:
a tread;
a crown reinforcement radially inward of the tread;
a pair of bead cores;
a carcass structure radially inward of the crown reinforcement and wound around the bead cores;
an innerliner radially inward of the carcass structure; and
a barrier layer interposed between the carcass structure and the innerliner, the barrier layer comprising two fabric pieces, one on each side of a center line of the pneumatic tire, one end of each fabric piece being located near the centerline of the pneumatic tire, the other end of each fabric piece being wrapped around the bead cores and terminating at least at the radial outermost part of the bead cores.

2. The pneumatic tire as set forth in claim 1 wherein the other end of each fabric piece is disposed between ⅙ and ¼ of a section width of the pneumatic tire from the centerline.

3. The pneumatic tire as set forth in claim 1 wherein the barrier layer is reinforced by fabric cords between 750 denier and 1000 denier.

4. The pneumatic tire as set forth in claim 3 wherein the barrier layer is reinforced by fabric cords of 842 denier.

5. The pneumatic tire as set forth in claim 1 wherein the barrier layer has an end count between 21 ends per inch and 35 ends per inch.

6. The pneumatic tire as set forth in claim 1 wherein the barrier layer is reinforced by nylon cords.

7. The pneumatic tire as set forth in claim 1 wherein the barrier layer is reinforced by cords at angles between 80 degrees and 90 degrees relative to a radial direction of the pneumatic tire.

8. The pneumatic tire as set forth in claim 7 wherein the cords have an 86 degree angle relative to the radial; direction.
